(19) United States
(12) Patent Application Publication
(10) Pub. No.: US 2026/0305698 A1
(43) Pub. Date: Oct. 8, 2026

(54) HEATING ASSEMBLY AND AEROSOL GENERATING APPARATUS

(71) Applicant: SHENZHEN FIRST UNION TECHNOLOGY CO., LTD., Shenzhen, Guangdong (CN)

(72) Inventors: Zhiming LU, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/996,689

(22) PCT Filed: Jul. 4, 2023
(86) PCT No.: PCT/CN2023/105762

§ 371 Date: Jan. 17, 2025

(30) Foreign Application Priority Data
Jul. 21, 2022 (CN) 202221892728.6

(51) Int. Cl. A24F 40/46

(52) U.S. Cl. CPC A24F 40/46

(57) ABSTRACT

A heating assembly and an aerosol generating apparatus are provided. The heating assembly includes; a base body, including a near end, a far end, and a surface extending between the near end and the far end; an infrared electrothermal coating, formed on the surface of the base body, the infrared electrothermal coating being configured to receive electric power to generate heat so as to generate infrared rays for irradiating and heating an aerosol-forming material; electrode connecting members, extending in an axial direction of the base body; and a holder, including an adhesive tape or a heat shrink tube, the holder being wound on the electrode connecting members or sleeving the electrode connecting members, so that the electrode connecting members are in contact and electrical connection with the infrared electrothermal coating.

This application claims priority to Chinese Patent Application No. 202221892728.6, filed with the China National Intellectual Property Administration on Jul. 21, 2022 and entitled “HEATING ASSEMBLY AND AEROSOL GENERATING APPARATUS”, which is incorporated herein by reference in its entirety.

### TECHNICAL FIELD

The present application relates to the field of electronic atomization technologies, and in particular, to a heating assembly and an aerosol generating apparatus.

### BACKGROUND

During use of smoking products (such as cigarettes or cigars), tobaccos are burnt to produce smoke. Attempts have been made to replace these tobacco-burning products by making products that release compounds without burning. An example of the products is a heating and non-burning product that releases a compound by heating rather than burning tobaccos.

An existing aerosol generating apparatus has the problem that a heating assembly component is complicated and is large in size, which is not conductive to heat insulation design and miniaturization.

### SUMMARY

The present application provides a heating assembly and an aerosol generating apparatus, and aims to solve the problem that a heating assembly of an existing aerosol generating apparatus is large in size, which is not conductive to heat insulation design and miniaturization.

One aspect of the present application provides a heating assembly, including:
a base body, including a near end, a far end, and a surface extending between the near end and the far end;
an infrared electrothermal coating, formed on the surface of the base body, the infrared electrothermal coating being configured to receive electric power to generate heat so as to generate infrared rays for irradiating and heating an aerosol-forming material;
electrode connecting members, extending in an axial direction of the base body; and
a holder, including an adhesive tape or a heat shrink tube, the holder being wound on the electrode connecting members or sleeved outside the electrode connecting members, so that the electrode connecting members are in contact and electrical connection with the infrared electrothermal coating.

Another aspect of the present application provides an aerosol generating apparatus. The aerosol generating apparatus includes:
a housing assembly;
the heating assembly, wherein the heating assembly is arranged in the housing assembly;
a battery cell, configured to provide power; and
a wire, one end of which is electrically connected to the battery cell, and the other end of which is fixedly connected to the electrode connecting members.

According to the heating assembly and the aerosol generating apparatus provided by the present application, by means of the adhesive tape or the heat shrink tube, the electrode connecting members are in contact and electrical connection with the infrared electrothermal coating, so that the heating assembly is simple in structure and small in size, thereby facilitating the heat insulation design and miniaturization of the aerosol generating apparatus.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generating apparatus according to an implementation of the present application;

FIG. 2 is a schematic exploded diagram of an aerosol generating apparatus according to an implementation of the present application;

FIG. 3 is a schematic diagram of a heating assembly according to an implementation of the present application;

FIG. 4 is a schematic exploded diagram of a heating assembly according to an implementation of the present application;

FIG. 5 is a schematic diagram of a heater in a heating assembly according to an implementation of the present application;

FIG. 6 is a schematic diagram of another heater according to an implementation of the present application;

FIG. 7 is a schematic diagram of still another heater according to an implementation of the present application; and

FIG. 8 is a schematic diagram of distribution of an infrared electrothermal coating and electrodes of still another heater according to an implementation of the present application.

In the drawings:

100. Aerosol generating apparatus; 3. Circuit board; 4. Button; 5. Heat insulation tube; 6. Housing assembly; 7. Battery cell; 11. Heater; 12. Electrode connecting member; 13. Temperature sensor; 14. Holder; 21. Base; 22. Base; 31. Charging interface; 61: Shell; 62. Fixing shell; 64. Bottom cap; 111. Base body; 112. Infrared electrothermal coating; 1121. Infrared electrothermal coating; 1122. Infrared electrothermal coating; 113. First electrode; 114. Second electrode; 115. Third electrode; 116. Fourth electrode; 621. Front shell; 622. Rear shell; and 641. Air inlet tube.

### DETAILED DESCRIPTION

For ease of understanding of the present application, the present application is described below in more detail with reference to the accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which the present application belongs. Terms used in this specification of the present disclosure herein are merely intended to describe objectives of the specific implementations, but are not intended to limit the present application. A term “and/or” used in this specification includes any or all combinations of one or more related listed items.

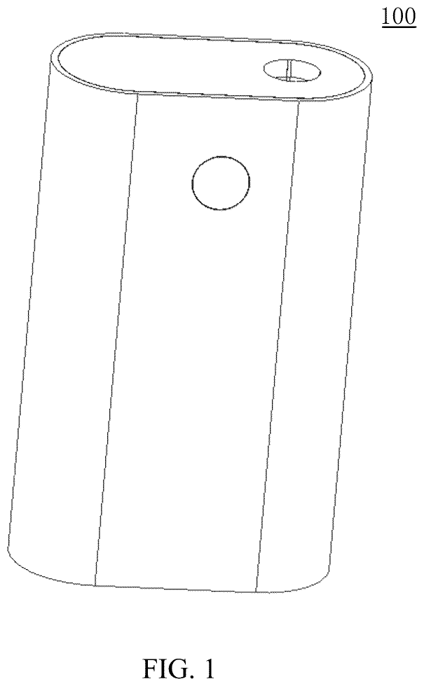

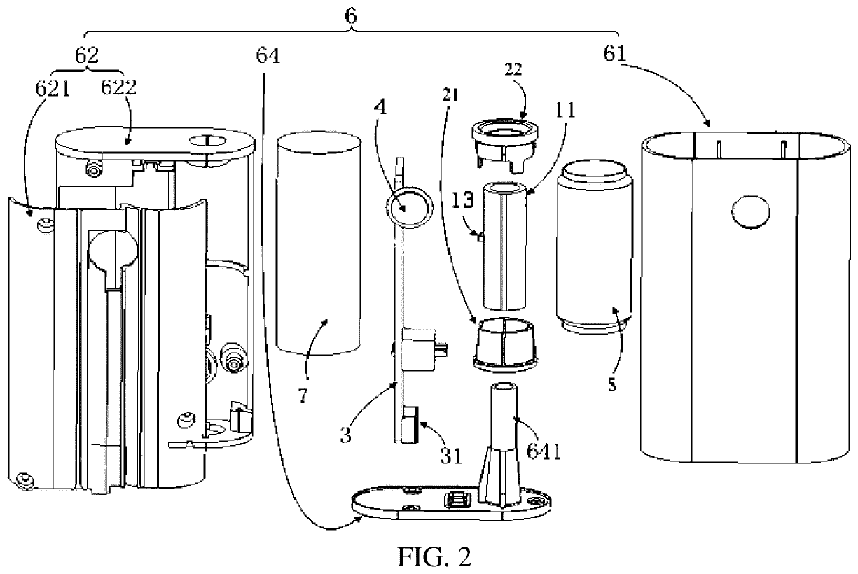

FIG. 1 to FIG. 2 show an aerosol generating apparatus 100 according to an implementation of the present application, including a housing assembly 6 and a heater 11. The heater 11 is arranged in the housing assembly 6. The heater 11 can radiate infrared rays to heat an aerosol-forming material, to produce an inhalable aerosol.

The housing assembly 6 includes a shell 61, a fixing shell 62, a base, and a bottom cap 64. Both the fixing shell 62 and the base are fixed in the shell 61. The base is configured to fix the heater 11. The base is arranged in the fixing shell 62. The bottom cap 64 is arranged at one end of the shell 61 and covers the shell 61. The fixing shell 62 is provided with an insertion port. The aerosol-forming material can be detachably received or inserted into the heater 11.

The base includes a base 22 that sleeves an upper end of the heater 11 and a base 21 that sleeves a lower end of the heater 11. Both the base 22 and the base 21 are arranged in the fixing shell 62. An air inlet tube 641 is arranged on the bottom cap 64 in a protruding manner. One end of the base 21 facing away from the base 22 is connected to the air inlet tube 641. The base 22, the heater 11, the base 21, and the air inlet tube 641 are coaxially arranged, and spaces between the heater 11 and the base 22, as well as between the heater 11 and the base 21 are sealed by seal members. The base 21 and the air inlet tube 641 are also sealed, and the air inlet tube 641 is communicated to external air for smooth air intake when a user inhales.

The aerosol generating apparatus 100 further includes a circuit board 3, a button 4, and a battery cell 7. The fixing shell 62 includes a front shell 621 and a rear shell 622. The front shell 621 is fixedly connected to the rear shell 622, and both the circuit board 3 and the battery cell 7 are arranged in the fixing shell 62. The battery cell 7 is electrically connected to the circuit board 3, and the button 4 is arranged the shell 61 in a penetrating manner. When the button 4 is pressed, the heater 11 can be powered on or powered off. The circuit board 3 is further connected to a charging interface 31. The charging interface 31 is exposed from the bottom cap 64. A user can charge or upgrade the aerosol generating apparatus 100 through the charging interface 31 to ensure continuous use of the aerosol generating apparatus 100.

The aerosol generating apparatus 100 further includes a heat insulation tube 5. The heat insulation tube 5 is arranged in the fixing shell 62. The heat insulation tube 5 is arranged at a periphery of the heater 11. The heat insulation tube 5 can prevent a large amount of heat from being transferred to the shell 61, which may cause the user to feel hot in the hands. The heat insulation tube includes a heat insulation material. The heat insulation material can be heat insulation glue, aerogel, an aerogel blanket, asbestos, aluminum silicate, calcium silicate, diatomite, zirconia, and the like. The heat insulation tube can also be a vacuum heat insulation tube. An infrared reflective coating may alternatively be formed in the heat insulation tube 5 to reflect the infrared rays emitted by the heater 11 towards the aerosol-forming material, thereby improving the heating efficiency.

The aerosol generating apparatus 100 further includes a temperature sensor 13, such as a Negative Temperature Coefficient (NTC), a Positive Temperature Coefficient (PTC), and a thermocouple, for detecting a real-time temperature of the heater 11 and transmitting the detected real-time temperature to the circuit board 3. The circuit board 3 adjusts a magnitude of current flowing through the heater 11 according to the real-time temperature. Specifically, when the temperature sensor 13 detects that the real-time temperature of the heater 11 is low, for example, when the temperature sensor 13 detects that the temperature of the heater 11 is less than 150° C., the circuit board 3 controls the battery cell 7 to output a high voltage to electrodes, thereby increasing the current fed into the heater 11, increasing the heating power of the aerosol-forming material, and reducing time required by a user for waiting to vape.

When the temperature sensor 13 detects that the temperature of the heater 11 is between 150° C. and 200° C., the circuit board 3 controls the battery cell 7 to output a normal voltage to the heater 11.

When the temperature sensor 13 detects that the temperature of the heater 11 is between 200° C. and 250° C., the circuit board 3 controls the battery cell 7 to output a low voltage to the heater 11. When the temperature sensor 13 detects that the temperature of the heater 11 is 250° C. and above, the circuit board 3 controls the battery cell 7 to stop outputting a voltage to the heater 11.

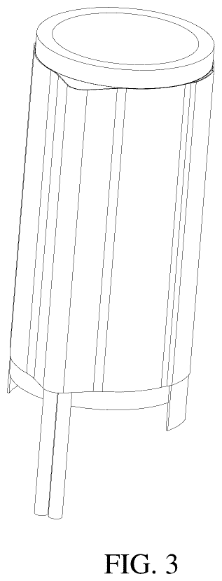

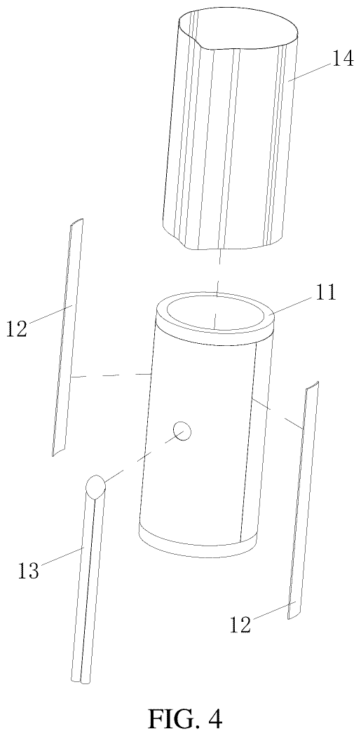

FIG. 3 to FIG. 5 show a heating assembly according to an implementation of the present application. The heating assembly includes a heater 11, electrode connecting members 12, a temperature sensor 13, and a holder 14. The heater 11 includes:
a base body 111, wherein a chamber suitable for accommodating an aerosol-forming material is formed in the base body 111.

Specifically, the base body 111 includes a near end, a far end, and a surface extending between the near end and the far end. The base body 111 is internally hollow to form a chamber suitable for accommodating an aerosol-forming product. The base body 111 may be in a shape of a cylinder or a prism, or in another columnar shape. The base body 111 is preferably in the shape of the cylinder, and the chamber is a cylindrical hole that penetrates through a middle part of the base body 111. An inner diameter of the hole is slightly greater than an outer diameter of the aerosol-forming product, so that the aerosol-forming product can be arranged in the chamber for heating. An inner diameter of the base body 111 is between 7 mm and 14 mm, or between 7 mm and 12 mm, or between 7 mm and 10 mm.

The base body 111 may be made of a material that is high-temperature resistant and can transmit infrared rays, such as quartz glass, ceramic, or mica, or may be made of another material having high infrared-ray transmittance, for example: a high-temperature-resistant material having an infrared-ray transmittance of at least 95%. The material of the base body is not specifically limited here.

The aerosol-forming material is a material that can release a volatile compound that can form an aerosol. The volatile compound may be released by heating the aerosol-forming material. The aerosol-forming material may be a solid or a liquid, or may include solid and liquid components. The aerosol-forming material may be loaded onto a carrier or a support through adsorption, coating, or impregnation, or in another manner. The aerosol-forming material may be conveniently be a part of the aerosol-forming product.

The aerosol-forming material may include nicotine. The aerosol-forming material may include tobaccos, for example, may include a tobacco-containing material including volatile compounds with a tobacco aroma. The volatile compounds with a tobacco aroma are released from the aerosol-forming material when the aerosol-forming material is heated. Preferably, the aerosol-forming material may include a homogeneous tobacco material, for example, a deciduous tobacco. The aerosol-forming material may include at least one aerosol-forming agent. The aerosol-forming agent may be any suitable known compound or a mixture of compounds. During use, the compound or the mixture of compounds facilitates dense and stable aerosol formation, and is substantially resistant to thermal degradation at an operating temperature of an aerosol generating system. Suitable aerosol-forming agents are well known in the related art, including but not limited to: polyol, such as triethylene glycol, 1,3-butanediol, and glycerol; a polyol ester, such as glycerol acetate, glycerol diacetate, or glycerol triacetate; and a fatty acid ester of a monocarboxylic acid, a dicarboxylic acid, or a polycarboxylic acid, such as dimethyl dodecanedioate and dimethyl tetradecanedioate. Preferably, the aerosol-forming agent is polyhydric alcohol or a mixture thereof, such as triethylene glycol, or 1,3-butanediol, and most preferably, glycerol.

An infrared electrothermal coating 112 may be formed on the surface of the base body 111. The infrared electrothermal coating 112 may be formed on an outer surface or an inner surface of the base body 111.

In this example, the infrared electrothermal coating 112 may be formed on an outer surface of the base body 111. The infrared electrothermal coating 112 generates heat under electric power, to generate an infrared ray with a specific wavelength, for example: a far infrared ray of 8 μm to 15 μm. When the wavelength of the infrared ray is matched with an absorption wavelength of the aerosol-forming material, energy of the infrared ray is easily absorbed by the aerosol-forming material.

The infrared electrothermal coating 112 is preferably formed by fully and uniformly mixing far infrared electrothermal ink, ceramic powder, and an inorganic adhesive, and is then coated on the outer surface of the base body 111. After being dried and cured for a specified period of time, the infrared electrothermal coating 112 has a thickness of 30 μm to 50 μm. Certainly, the infrared electrothermal coating 112 may further be formed by mixing and stirring stannic chloride, tin oxide, antimony butter, titanium tetrachloride, and anhydrous cupric sulfate according to a specific ratio, and is then coated on the outer surface of the base body 111. Alternatively, the infrared electrothermal coating may be one of a silicon carbide ceramic layer, a carbon fiber composite layer, a zirconium-titanium oxide ceramic layer, a zirconium-titanium nitride ceramic layer, a zirconium-titanium boride ceramic layer, a zirconium-titanium carbide ceramic layer, a ferric oxide ceramic layer, a ferric nitride ceramic layer, a ferric boride ceramic layer, a ferric carbide ceramic layer, a rare-earth oxide ceramic layer, a rare-earth nitride ceramic layer, a rare-earth boride ceramic layer, a rare-earth carbide ceramic layer, a nickel-cobalt oxide ceramic layer, a nickel-cobalt nitride ceramic layer, a nickel-cobalt boride ceramic layer, a nickel-cobalt carbide ceramic layer, or a high silica molecular sieve ceramic layer. The infrared electrothermal coating 112 may alternatively be an existing coating made of another material.

The electrodes include a first electrode 113 and a second electrode 114 which are spaced apart on the base body 111 and are configured to feed electric power supplied by the battery cell 7 to the infrared electrothermal coating 112.

Both the first electrode 113 and the second electrode 114 are electrically connected to the infrared electrothermal coating 112. The first electrode 113 and the second electrode 114 are both conductive coatings. The conductive coatings may be metal coatings. The metal coatings may include silver, gold, palladium, platinum, copper, nickel, molybdenum, tungsten, niobium, or an alloy material of the above metals.

The first electrode 113 and the second electrode 114 are symmetrically arranged along a center axis of the base body 111. Both the first electrode 113 and the second electrode 114 extend in an axial direction of the base body 111and are long-strip-shaped. Axial extension lengths of both the first electrode 113 and the second electrode 114 are the same as an axial extension length of the infrared electrothermal coating 112. Circumferential extension lengths or widths of both the first electrode 113 and the second electrode 114 are between 0.2 mm and 5 mm, preferably between 0.2 mm and 4 mm, further preferably between 0.2 mm and 3 mm, further preferably between 0.2 mm and 2 mm, and further preferably between 0.5 mm and 2 mm. In this way, the first electrode 113 and the second electrode 114 separate the infrared electrothermal coating 112 into two infrared electrothermal sub-coatings in a circumferential direction of the base body 111. After the first electrode 113 and the second electrode 114 are turned on, current can flow from one electrode to the other electrode approximately in the circumferential direction of the base body 111 through the infrared electrothermal coating 112.

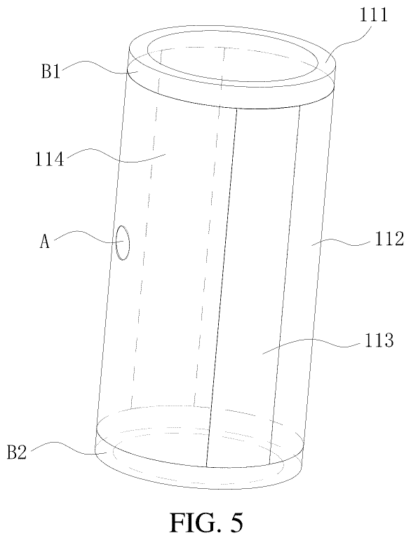

In an example, the electrodes or the infrared electrothermal coating 112 can be spaced apart from the near end or far end of the base body 111. For example: In FIG. 5, part B1 and part B2 on the outer surface of the base body 111 are not provided with the electrodes or the infrared electrothermal coating 112. Axial extension lengths of part B1 and part B2 can be minimized as much as possible. Generally, the axial extension lengths of part B1 and part B2 range from 0 to 1 mm, namely, greater than 0 and less than or equal to 1 mm. In a specific example, the axial extension lengths can be 0.2 mm, 0.4 mm, 0.5 mm, 0.7 mm, and the like.

In an example, each electrode or the infrared electrothermal coating 112 is not spaced apart from the near end or far end of the base body 111, namely, it is also feasible that the axial extension length of the electrode or the axial extension length of the infrared electrothermal coating 112 is the same as the axial extension length of the base body 111. In this way, on the one hand, a coating area of the infrared electrothermal coating 112 can be enlarged, and on the other hand, heat loss can be avoided.

The electrode connecting members 12 maintain contact with the electrodes to form electrical connection. A number of the electrode connecting members 12 is consistent with a number of the electrodes, namely, the first electrode 113 has a corresponding electrode connecting member 12, and the second electrode 114 has a corresponding electrode connecting member 12. The electrode connecting members 12 can be electrically connected to the battery cell 7 through wires. For example: One end of each wire is welded to the electrode connecting member 12, and the other end of the wire is electrically connected to the battery cell 7 (which can be connected to the battery cell 7 through the circuit board 3 or directly). The electrode connecting members 12 are preferably made of copper, a copper alloy, aluminum, or an aluminum alloy with good conductivity, with silver or gold plated on surfaces, to reduce contact resistance and improve the welding performance of the surfaces of the materials.

Similar to the electrodes, the electrode connecting members 12 extend in the axial direction of the base body 111 and are strip-shaped. An axial extension length of each electrode connecting member 12 can be the same as the axial extension length of each electrode or the infrared electrothermal coating 112. A circumferential extension length or width of each electrode connecting member 12 is between 0.2 mm and 5 mm, preferably between 0.2 mm and 4 mm, further preferably between 0.2 mm and 3 mm, and further preferably between 0.2 mm and 2 mm, and further preferably between 0.5 mm and 2 mm. A thickness of each electrode connecting member 12 is between 0.05 mm and 1 mm, namely, the electrode connecting member 12 can be made thinner. In a specific example, the thickness of each electrode connecting member 12 may be 0.1 mm, 0.2 mm, 0.4 mm, 0.5 mm, and the like. In a preferred embodiment, the axial extension length of each electrode connecting member 12 is greater than the axial extension length of each electrode or the infrared electrothermal coating 112, but less than a sum of the axial extension length of the electrode or the infrared electrothermal coating 112 and the axial extension length of part B2. Or, the axial extension length of each electrode connecting member 12 is greater than a sum of the axial extension length of the electrode or the infrared electrothermal coating 112 and the axial extension length of part B2, namely, an upper end of the electrode connecting member 12 is flush with an upper end of the electrode or the infrared electrothermal coating 112, and a lower end of the electrode connecting member 12 extends out of the far end of the base body 111. In this way, it is beneficial for welding the wire onto the electrode connecting member 12. In a further preferred implementation, a distance between the lower end of each electrode connecting member 12 and the far end of the base body 111 is between 1 mm and 10 mm, preferably between 1 mm and 8 mm, further preferably between 1 mm and 6 mm, and further preferably between 1 mm and 4 mm.

A label A of a preset position is provided on the outer surface of the base body 111, so that a user can assemble, i.e. locate, the temperature sensor 13 to the preset position according to the label A. The label A can be that pigment is marked at the preset position by printing, spraying, or the like. Usually, the preset position is at an axial middle position of the infrared electrothermal coating 112. In this way, the temperature sensor 13 may obtain an optimal temperature of the heater 11.

The holder 14 is configured to hold the electrode connecting members 12 on the electrodes and/or maintain the temperature sensor 13 at the label A. The holder 14 includes a high-temperature adhesive tape or a heat shrink tube. In practical applications, the high-temperature adhesive tape can be directly wrapped around the electrode connecting members 12 and/or the temperature sensor 13. Or, the heat shrink tube sleeves the electrode connecting members 12 and/or the temperature sensor 13, and is then heated to shrink and secure the electrode connecting members 12 and/or the temperature sensor 13. In a preferred implementation, the electrode connecting members 12 are partially exposed out of the holder 14. In this way, it is beneficial for welding the wire onto the electrode connecting member 12.

It should be noted that, in other examples, it is also feasible that the electrode connecting members 12 can be in direct contact with and electrically connected to the infrared electrothermal coating 112. In this case, it is also feasible that the first electrode 113 and/or the second electrode 114 are not provided.

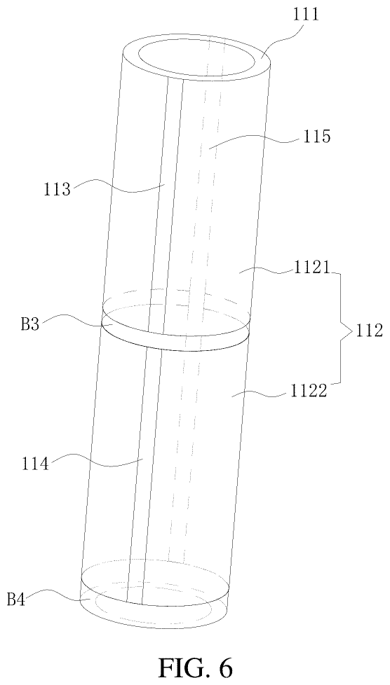

FIG. 6 shows another heater according to an implementation of the present application. What is different from the examples of FIG. 3 to FIG. 5 is as follows:

Part B3 on the outer surface of the base body 111 separates the infrared electrothermal coating 112 into two independently controllable heating regions, namely an infrared electrothermal coating 1121 and an infrared electrothermal coating 1122. An axial extension length of part B3 can be as small as possible, such as 0.4 mm to 1 mm, preferably 0.4 mm to 0.8 mm, and further preferably 0.5 mm.

The electrodes further include a third electrode 115 spaced apart on the base body 111, namely, the first electrode 113, the second electrode 114, and the third electrode 115 are all spaced apart from each other. The third electrode 115 maintains contact with both the infrared electrothermal coating 1121 and the infrared electrothermal coating 1122 to form electrical connection. The first electrode 113 maintains contact with the infrared electrothermal coating 1121 to form electrical connection. The second electrode 114 maintains contact with the infrared electrothermal coating 1122 to form electrical connection.

In this way, by controlling the first electrode 113, the second electrode 114, and the third electrode 115 to be powered on, segmented heating of the aerosol-forming material can be achieved. For example: The infrared electrothermal coating 1121 is first activated for heating (controlling the first electrode 113 and the third electrode 115 to be powered on), and the infrared electrothermal coating 1122 is then activated for heating (controlling the second electrode 114 and the third electrode 115 to be powered on). Or, the infrared electrothermal coating 1121 is first activated for heating (controlling the first electrode 113 and the third electrode 115 to be powered on), and the infrared electrothermal coating 1121 and the infrared electrothermal coating 1122 are then activated for heating together (controlling the first electrode 113, the second electrode 114, and the third electrode 115 to be powered on together).

In an example of FIG. 6, the infrared electrothermal coating 1121 is not spaced apart from the near end of the base body 111, and the infrared electrothermal coating 1122 is spaced apart from the far end of the base body 111 (referring to B4 in the figure).

In the example of FIG. 6, an axial extension length of the third electrode 115 is a sum of an axial extension length of the infrared electrothermal coating 1121, an axial extension length of part B3, and an axial extension length of the infrared electrothermal coating 1122. The axial extension length of the first electrode 113 is the same as the axial extension length of the infrared electrothermal coating 1121. The axial extension length of the second electrode 114 is the same as the axial extension length of the infrared electrothermal coating 1122.

Similar to the examples in FIG. 3 to FIG. 5, one or more temperature sensors 13 can be used to measure a temperature of a region where the infrared electrothermal coating 1121 and/or 1122 are located, which can then be used to control the temperature of the heater 11.

Similar to the examples in FIG. 3 to FIG. 5, labels corresponding to the temperature sensor 13 can be provided on the infrared electrothermal coating 1121 and/or the infrared electrothermal coating 1122.

Similar to the examples in FIG. 3 to FIG. 5, the electrode connecting members 12 can be used to maintain contact with the electrodes and electrical connection to the battery cell 7.

In a preferred implementation, an axial extension length of the electrode connecting member 12 corresponding to the third electrode 115 is greater than a sum of an axial extension length of the third electrode 115 and an axial extension length of part B4, namely, an upper end of the electrode connecting member 12 corresponding to the third electrode 115 is flush with the third electrode 115, and a lower end extends out of the far end of the base body 111. An axial extension length of the electrode connecting member 12 corresponding to the first electrode 113 is the same as an axial extension length of the first electrode 113. An axial extension length of the electrode connecting member 12 corresponding to the second electrode 114 is greater than a sum of an axial extension length of the second electrode 114 and an axial extension length of part B4, namely, an upper end of the electrode connecting member 12 corresponding to the second electrode 114 is flush with the second electrode 114, and a lower end extends out of the far end of the base body 111. In this way, one end of the wire corresponding to each electrode connecting member 12 can be welded to the electrode connecting member 12, and the other end can extend from the far end of the base body 111 to be electrically connected to the battery cell 7.

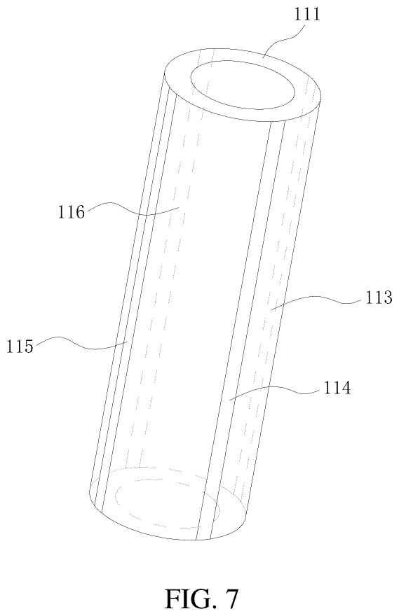

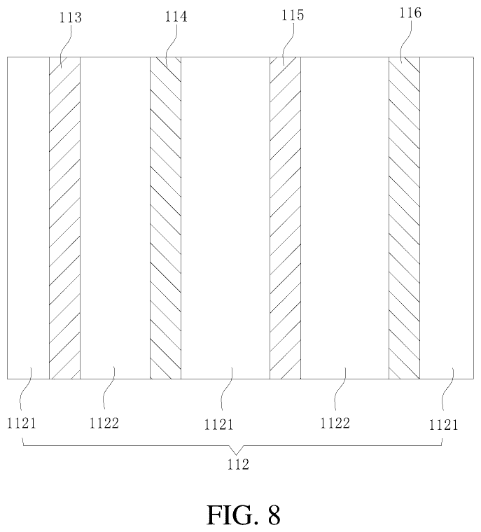

FIG. 7 and FIG. 8 show still another heater according to an implementation of the present application. What is different from the examples of FIG. 3 to FIG. 5 is as follows:

The entire outer surface of base body 11 is formed with an infrared electrothermal coating 112. The electrodes include a first electrode 113, a second electrode 114, a third electrode 115, and a fourth electrode 116 which are spaced apart on the base body 111. In this way, the first electrode 113, the second electrode 114, the third electrode 115, and the fourth electrode 116 divide the infrared electrothermal coating 112 into four infrared electrothermal coatings distributed in sequence in a circumferential direction. When the first electrode 113 and the third electrode 115, as well as the third electrode 115 and the fourth electrode 116, are controlled to be powered on, the infrared electrothermal coating 1122 between the first electrode 113 and the second electrode 114, and the infrared electrothermal coating 1122 between the third electrode 115 and the fourth electrode 116 radiate infrared rays under electric power to heat an aerosol-forming material, and the infrared electrothermal coating 1121 between the first electrode 113 and the fourth electrode 116, and the infrared electrothermal coating 1121 between the third electrode 115 and the second electrode 114 are short-circuited. On the contrary, the infrared electrothermal coating 1121 between the first electrode 113 and the fourth electrode 116, and the infrared electrothermal coating 1121 between the third electrode 115 and the second electrode 114 radiate infrared rays under electric power to heat an aerosol-forming material, and the infrared electrothermal coating 1122 between the first electrode 113 and the second electrode 114, and the infrared electrothermal coating 1122 between the third electrode 115 and the fourth electrode 116 are short-circuited.

In the examples in FIG. 7 to FIG. 8, axial extension lengths of the first electrode 113, the second electrode 114, the third electrode 115, and the fourth electrode 116 are all the same as an axial extension length of the infrared electrothermal coating 1121 or the infrared electrothermal coating 1122.

It should be noted that, the electrode design can be applied to the examples in FIG. 6 and FIG. 7 to FIG. 8. For example: similar to the example in FIG. 6, in the examples in FIG. 7 to FIG. 8, three electrodes can be used to achieve segmented heating. Similar to the examples in FIG. 7 to FIG. 8, in the example in FIG. 6, four electrodes can be used to achieve segmented heating (two axially extending electrodes are arranged on each of the infrared electrothermal coating 1121 and the infrared electrothermal coating 1122).

It should be noted that, the specification of the present application and the accompanying drawings thereof illustrate preferred embodiments of the present application. However, the present application may be implemented in various different forms, and is not limited to the embodiments described in this specification. These embodiments are not intended to be an additional limitation on the content of the present application, and are provided for the purpose of providing a more thorough and comprehensive understanding of the content disclosed in the present application. Moreover, the foregoing technical features are further combined to form various embodiments not listed above, and all such embodiments shall be construed as falling within the scope of the present application. Further, a person of ordinary skill in the art can make improvements or transformations according to the above description, and all these improvements and transformations should fall within the scope of protection of the claims attached to the present application.

1. A heating assembly, comprising:
a base body, comprising a near end, a far end, and a surface extending between the near end and the far end;
an infrared electrothermal coating, formed on the surface of the base body, the infrared electrothermal coating being configured to receive electric power to generate heat so as to generate infrared rays for irradiating and heating an aerosol-forming material;
electrode connecting members, extending in an axial direction of the base body; and
a holder, comprising an adhesive tape or a heat shrink tube, the holder being wound on the electrode connecting members or sleeved outside the electrode connecting members, so that the electrode connecting members are in contact and electrical connection with the infrared electrothermal coating.

2. The heating assembly according to claim 1, wherein the base body is configured to be an internally hollow tube, and the internally hollow part is formed into a chamber for accommodating the aerosol-forming material.

3. The heating assembly according to claim 1, wherein an axial extension length of the infrared electrothermal coating is less than or equal to an axial extension length of the base body.

4. The heating assembly according to claim 1, wherein the infrared electrothermal coating and the near end or far end of the base body are spaced apart, and a spacing distance is between 0 mm and 1 mm.

5. The heating assembly according to claim 1, wherein an axial extension length of each electrode connecting member is the same as the axial extension length of the infrared electrothermal coating.

6. The heating assembly according to claim 1, wherein one end of each electrode connecting member is flush with one end of the infrared electrothermal coating, and the other end of the electrode connecting member extends out of the near end or far end of the base body.

7. The heating assembly according to claim 6, wherein a distance between the other end of each electrode connecting member and the near end or far end of the base body is between 1 mm and 10 mm.

8. The heating assembly according to claim 1, wherein a width of each electrode connecting member is between 0.2 mm and 5 mm; and/or, a thickness of each electrode connecting member is between 0.05 mm and 1 mm.

9. The heating assembly according to claim 1, further comprising electrodes formed on the base body, wherein the electrodes comprise a first electrode and a second electrode which are configured to feed the electric power to the infrared electrothermal coating.

10. The heating assembly according to claim 9, wherein both the first electrode and the second electrode extend in the axial direction of the base body, and axial extension lengths of both the first electrode and the second electrode are the same as an axial extension length of the infrared electrothermal coating.

11. The heating assembly according to claim 9, wherein the first electrode and the second electrode are symmetrically arranged along a center axis of the base body.

12. The heating assembly according to claim 9, wherein a width of the first electrode or the second electrode is between 0.2 mm and 5 mm.

13. The heating assembly according to claim 9, wherein the electrode connecting members are in contact with the infrared electrothermal coating through the electrodes.

14. The heating assembly according to claim 9, wherein the electrodes further comprise a third electrode formed on the base body; the infrared electrothermal coating comprises a first infrared electrothermal coating and a second infrared electrothermal coating which are spaced apart;
the first electrode and the third electrode feed first electric power to the first infrared electrothermal coating, and the second electrode and the third electrode feed second electric power to the second infrared electrothermal coating;
an axial extension length of the first electrode is the same as an axial extension length of the first infrared electrothermal coating; an axial extension length of the second electrode is the same as an axial extension length of the second infrared electrothermal coating; an axial extension length of the third electrode is equal to a sum of the axial extension length of the first infrared electrothermal coating, the axial extension length of the second infrared electrothermal coating, and a spacing distance between the first infrared electrothermal coating and the second infrared electrothermal coating; or, an axial extension length of the first infrared electrothermal coating is the same as an axial extension length of the second infrared electrothermal coating; axial extension lengths of the first electrode, the second electrode, and the third electrode are the same as the axial extension length of the first infrared electrothermal coating or the second infrared electrothermal coating.

15. The heating assembly according to claim 9, wherein the electrodes further comprise a third electrode and a fourth electrode which are formed on the base body; the infrared electrothermal coating comprises a first infrared electrothermal coating and a second infrared electrothermal coating which are spaced apart;
the first electrode and the second electrode feed first electric power to the first infrared electrothermal coating, and the third electrode and the fourth electrode feed second electric power to the second infrared electrothermal coating;
axial extension lengths of both the first electrode and the second electrode are the same as an axial extension length of the first infrared electrothermal coating, and axial extension lengths of both the third electrode and the fourth electrode are the same as an axial extension length of the second infrared electrothermal coating; or, the axial extension length of the first infrared electrothermal coating is the same as the axial extension length of the second infrared electrothermal coating; and the axial extension lengths of the first electrode, the second electrode, the third electrode, and the fourth electrode are the same as the axial extension length of the first infrared electrothermal coating or the second infrared electrothermal coating.

16. The heating assembly according to claim 1, further comprising a temperature sensor configured to detect a temperature, wherein a label of a preset position is arranged on the surface of the base body; and the label is configured to achieve positioning during assembling of the temperature sensor.

17. An aerosol generating apparatus, comprising:
a housing assembly;
the heating assembly according to claim 1, wherein the heating assembly is arranged in the housing assembly;
a battery cell, configured to provide electric power; and
a wire, one end of which is electrically connected to the battery cell, and the other end of which is fixedly connected to the electrode connecting members.
